(19) United States
(12) Patent Application Publication
(10) Pub. No.: US 2014/0233954 A1
(43) Pub. Date: Aug. 21, 2014

(54) LINK ESTABLISHMENT METHOD FOR MULTI-WAVELENGTH PASSIVE OPTICAL NETWORK SYSTEM

(71) Applicant: Electronics and Telecommunications Research Institute, Daejeon-si (KR)

(72) Inventors: Han-Hyub LEE, Daejeon-si (KR); Eun-Gu LEE, Daejeon-si (KR); Sang-Soo LEE, Daejeon-si (KR)

(73) Assignee: Electronics and Telecommunications Research Institute, Daejeon-si (KR)

(21) Appl. No.: 14/186,755

(22) Filed: Feb. 21, 2014

(30) Foreign Application Priority Data
Feb. 21, 2013 (KR) 10-2013-0018853
Feb. 21, 2014 (KR) 10-2014-0019990

(51) Int. Cl. H04J 14/02; H04B 10/272

(52) U.S. Cl. CPC H04J 14/0242; H04B 10/272; H04J 14/0246; H04J 14/025
USPC 398/72

(57) ABSTRACT

Provided is a method of establishing a link between service provider equipment and subscriber equipment in a multi-wavelength passive optical network system. The method of establishing a link includes acquiring information about a wavelength plan of allocated wavelengths in the MW PON system; transmitting a first signal wavelength initialization request signal on a first upstream wavelength from physical layer to the service provider equipment; waiting for a response from the service provider equipment for a predetermined time interval after transmitting the first signal wavelength initialization request signal; and in response to failing to receive a response to the first signal-wavelength initialization request signal within the predetermined time interval, transmitting a second signal wavelength initialization request signal on a second upstream wavelength to the service provider equipment after the waiting.

### CROSS-REFERENCE TO RELATED APPLICATION(S)

This application claims priority from Korean Patent Application Nos. 10-2013-0018853, filed on Feb. 21, 2013, and 10-2014-0019990, filed on Feb. 21, 2014 in the Korean Intellectual Property Office, the disclosures of which are incorporated herein by references in entirety.

### BACKGROUND

1. Field

The present invention relates to a passive optical network (PON), and more particularly, to link establishment process for a multi-wavelength passive optical network (MW PON) system.

2. Description of the Related Art

As optical communication technology is advanced and the demand for the Internet service increases rapidly, fundamental research on an optical access network has been conducted since the early 2000s, and thus introduction of a broadband convergence network (which directly connects an office or a central office (CO) to subscriber equipments through an optical fiber) such as fiber to the home (FTTH) and fiber to the office (FTTO) is generalized. Herewith, research on next generation high-speed and large-capacity optical access network technology is being actively done for responding to an explosive increase in traffic due to the spread of mobile Internet protocol (IP) terminals such as smartphones or tablet computers, the commercialization of an IP television (IPTV) service, and the spread of a multimedia broadcast/streaming service over the Internet.

As a method for efficiently providing a service to more subscriber equipments with limited network resources, a time division multiplexing (TDM) technique and a wavelength division multiplexing (WDM) technique are being applied to optical access network technology. Recently, research is being conducted on an optical access network using a hybrid technique in which both the TDM technique and the WDM technique are applied. Attempts to apply an orthogonal frequency division multiplexing (OFDM) technique (which is mainly used in wireless communication at present) to the optical access network technology are also being actively made, which is an example of the hybrid technique in a broad sense.

Among the techniques, the WDM technique or the hybrid technique may perform communication using a plurality of wavelength bands, namely, a multi-wavelength. As the use of the Internet increases and demand for multimedia contents increases explosively, increasing a bandwidth of a network in a wired optical access network and a wireless network or a merged wired/wireless network thereof is becoming an increasingly important issue, and particularly, a technique using a multi-wavelength is attracting an attention as a type of method for solving the important issue. According to this, it is possible not only to provide a super high-speed communication service to many subscriber equipments, but also to easily expand a communication capacity and the number of subscriber equipments with an excellent communication security. Therefore, in the next generation super high-speed large-scale optical access network technology, a MW PON using the WDM technique or the hybrid technique is obtaining a great interest.

A MW PON system may include a service provider equipment (hereinafter referred to as “an optical line terminal (OLT)”) installed in a CO, a user terminal unit or a number of subscriber equipments (hereinafter referred to as “an optical network unit (ONU)”) neighboring thereto, and a local node in which one or more optical multiplexers/de-multiplexers or light intensity splitters are installed or an optical distribution network (hereinafter referred to as “an optical distribution unit (ODN)”). In the MW PON system, a network configuration may be varied depending on the kind of used light source, for example, a spectrum-split light source, a wavelength-locked light source, or a wavelength-independent light source.

Further, a wavelength of light used between an OLT and a specific ONU in the MW PON system may be fixed or varied. In the former case, if the ONU is installed at the network system for the first time, a process of establishing a communication link between an OLT and the ONU by allocating a wavelength for use by the ONU is required. In the latter case, a process of establishing a communication link between the ONU and the OLT by allocating a wavelength is required even when a used wavelength is changed to a new wavelength, as well as when the ONU is the first ONU installed at the MW PON system.

However, as described above, the network configuration of the MW PON system may vary depending on at least one or more of: the type of a used light source; whether another multiplexing scheme is used in a hybrid manner; the presence of the wavelength-tuning functionality in an ONU; and a wavelength tuning scheme of an ONU. The change in network configuration may vary the link establishment procedures that include the allocation of wavelengths between an OLT and an ONU. If the link establishment procedures are changed, including the wavelength allocation, according to the network configuration, the devices and equipment used to build the MW PON system are not compatible with one another, which hinder establishing a network and also increase investment expenditure on equipment, resulting in an increase in the user cost.

### SUMMARY

One object of the present disclosure is to provide procedures of establishing a link in a multi-wavelength passive optical network (MW PON) system, which can be flexibly applied, regardless of a network configuration of the MW PON system, and ensure the compatibility with the existing products.

Another object of the present disclosure is to provide procedures of establishing a link in an MW PON system including wavelength-tunable subscriber equipment (i.e., an optical network unit) or in a time-wavelength division multiplexing passive optical network (TWDM PON) system.

In one general aspect, there is provided a method of establishing a link in a multi-wavelength passive optical network (MW PON) system, the method including: initializing a signal wavelength between service provider equipment and subscriber equipment which are included in the MW PON system, wherein the initializing of the signal wavelength comprises transmitting and receiving signals between physical layer of the service provider equipment and physical layer of the subscriber equipment.

In a case where the subscriber equipment is installed in the MW PON system, the transmitting and receiving of the signals may be performed during physical installation of the subscriber equipment.

The transmitting and receiving of the signal may include transmitting a first signal wavelength initialization request signal on a first upstream wavelength from the physical layer of the subscriber equipment to the service provider equipment, and receiving a signal wavelength initialization response signal on a first downstream wavelength from the physical layer of the service provider equipment.

The transmitting of the signal may include transmitting the first signal wavelength initialization request signal on the first upstream wavelength based on information about a wavelength plan of the MW PON system which has been previously obtained prior to the transmitting of the signal.

The receiving of the signal may include receiving the signal wavelength initialization response signal that is automatically transmitted from the physical layer of the service provider equipment.

The receiving of the signal may include receiving the signal wavelength initialization response signal that is transmitted after wavelength allocation to the subscriber equipment is checked at media access control (MAC) layer of the service provider equipment.

The method may further include: waiting for a response for a predetermined time interval after transmitting the first signal wavelength request signal; and in response to failing to receive the signal wavelength initialization request signal during the waiting, transmitting a second signal wavelength initialization request signal on a second upstream wavelength to the service provider equipment after the predetermined time interval.

The method may further include: waiting for a response for a predetermined time interval after transmitting the second signal wavelength initialization request signal; and in response to failing to receive the signal wavelength initialization request signal during the waiting, transmitting a third signal wavelength initialization request signal on a third upstream wavelength to the service provider equipment after the predetermined time interval.

The time interval may be “2τP+τOffice+τG,” where τP represents a propagation delay time, τG represents a signal processing time of an optical network unit and τG represents a guard time.

In another general aspect, there is provided a method of subscriber equipment to establish a link to service provider equipment in a multi-wavelength passive optical network (MW PON) system, the method including operations of: (a) acquiring information about a wavelength plan of allocated signal wavelengths in the MW PON system; (b) transmitting a first signal wavelength initialization request signal on a first upstream wavelength from physical layer of the subscriber equipment to the service provider equipment; (c) waiting for a response from the service provider equipment for a predetermined time interval after transmitting the first signal wavelength initialization request signal; and (d) in response to failing to receive a response to the first signal wavelength initialization request signal within the predetermined time interval, transmitting a second signal wavelength initialization request signal on a second upstream wavelength to the service provider equipment after the waiting.

The method may further include operations of: (e) waiting for a response from the service provider equipment for a predetermined time interval after transmitting the second signal wavelength initialization request signal; and (f) in response to failing to receive a response to the second signal wavelength initialization request signal within the predetermined time interval, transmitting a third signal wavelength initialization request signal on a third upstream wavelength after the waiting.

The time interval may be “2τP+τOffice+τG,” where τP represents a propagation delay time, τG represents a signal processing time of an optical network unit and τG represents a guard time.

The operation (a) may include receiving a first downstream signal from the service provider equipment and the first upstream wavelength is identified by information contained in the first downstream signal.

The operation (d) may include receiving a second downstream signal from the service provider equipment, and the second upstream wavelength is identified by information contained in the second downstream signal.

Other features and aspects will be apparent from the following detailed description, the drawings, and the claims.

### BRIEF DESCRIPTION OF THE DRAWINGS

FIG. 1A is a block diagram illustrating an example of a multi-wavelength passive optical network (MW PON) system including a wavelength-tunable optical network unit (ONU).

FIG. 1B is a block diagram illustrating another example of the MW PON system.

FIG. 1C is a block diagram illustrating an example of the MW PON system illustrated in FIG. 1B.

FIG. 2 is a flowchart illustrating link establishment procedures in an MW PON system according to an exemplary embodiment.

FIG. 3 is a flowchart illustrating procedures for establishing a link in an MW PON system according to another exemplary embodiment.

FIG. 4 is a graph showing characteristics of an optical filter for measurement of an upstream signal or a downstream signal in an MW PON.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

Throughout the drawings and the detailed description, unless otherwise described, the same drawing reference numerals are understood to refer to the same elements, features, and structures. The relative size and depiction of these elements may be exaggerated for clarity, illustration, and convenience.

A method of establishing a link for communications between an optical line terminal (OLT) and an optical network unit (ONU) in accordance with exemplary embodiments described hereinafter may be applicable to a multi-wavelength passive optical network (MW PON) system. The MW PON system is not limited to a wavelength-division multiplexing passive optical network (WDM PON) system, and may be a hybrid PON with a WDM scheme, such as a time division multiplexing passive optical network (TWDM PON) system. However, the TWDM PON system may be a system that employs an orthogonal frequency division multiplexing (OFDM) scheme as its communication method, or a system that does not employ it.

In addition, the ONU of the MW PON system may provide a wavelength-tuning functionality (for example, wavelength-tunable light source and a wavelength-tunable filter), and an exemplary embodiment described herein may be applicable to a system including the ONU with the wavelength-tuning functionality. However, other exemplary embodiments of the present disclosure are not limited thereto. For example, another exemplary embodiment of the present disclosure may be applied to link establishment process for a case where new subscriber equipment is installed in an MW PON system, in particular, a local node of a PON system, and in this case, the subscriber equipment does not have to possess the wavelength-tuning functionality. In addition, the exemplary embodiment may be applied to a case where subscriber equipment, which has been installed in an MW PON system and has already had a link to service provider equipment unit using a predetermined wavelength, establishes a new link using a different wavelength.

As such, in the MW PON system, the ONU may need initial tuning of a signal wavelength to a predetermined allocated signal wavelength, and even the allocated signal wavelength may be changed to another wavelength. There may be several cases where the used wavelength is changed. For example, the wavelength tuning time may be used for a case that moves to a newly allocated wavelength channel in the middle of activating an ONU of the MW PON system or subsequently to the activation. For another example, the wavelength tuning time may be used for a case in which, in the MW PON system including a plurality of OLTs, an operation of some OLTs is stopped for operating in a power save mode and ONUs connected thereto move to a wavelength channel to be communicable with other operating OLT. For another example, the wavelength tuning time may be used for a case that desires to dynamically allocate a wavelength resource in the MW PON system or a case that desires to check a performance such as an output wavelength of the wavelength-tunable light source being drifted or being well maintained within a predetermined grid.

A process of establishing a link between the service provider equipment (i.e., OLT) and the subscriber equipment (i.e., ONU) may vary in specific procedures, depending on a kind or configuration of the MW PON, but it may be performed in several cases. For example, an ONU newly activated in an activation process of the ONU may need tuning of a wavelength to a certain allocated wavelength. Further, even when the existing allocated signal wavelength is changed to another wavelength after the ONU is activated, the ONU may need tuning of a wavelength to a newly allocated signal wavelength. Changing an allocated signal wavelength may be performed when a manager of a network system purposes to manage wavelength resources, or to enhance a performance through load balancing of the network system, but the aspect of the present disclosure is not limited thereto.

The MW PON including the wavelength-tunable light source may be used for various types of networks as well as the existing optical communication network. As an example thereof, the MW PON system is used as a backbone network for a split type wireless base station. In the split type wireless base station, a remote controller (REC) and a remote end (RE) are separately installed. The REC processes a digital baseband signal and controls and manages a wireless base station, and the RE performs filtering, modulation, frequency conversion, and amplification on an analog radio frequency (RF) signal, and transmits/receives the analog RF signal through an antenna. In the split type wireless base station, only the RE is installed inside a cell, and the REC is installed in a central office, thus enabling an efficient cell operation. Further, one or more RECs and a plurality of the REs may constitute a network as an MW PON. Hereinafter, an architecture of the MW PON will be first described in brief.

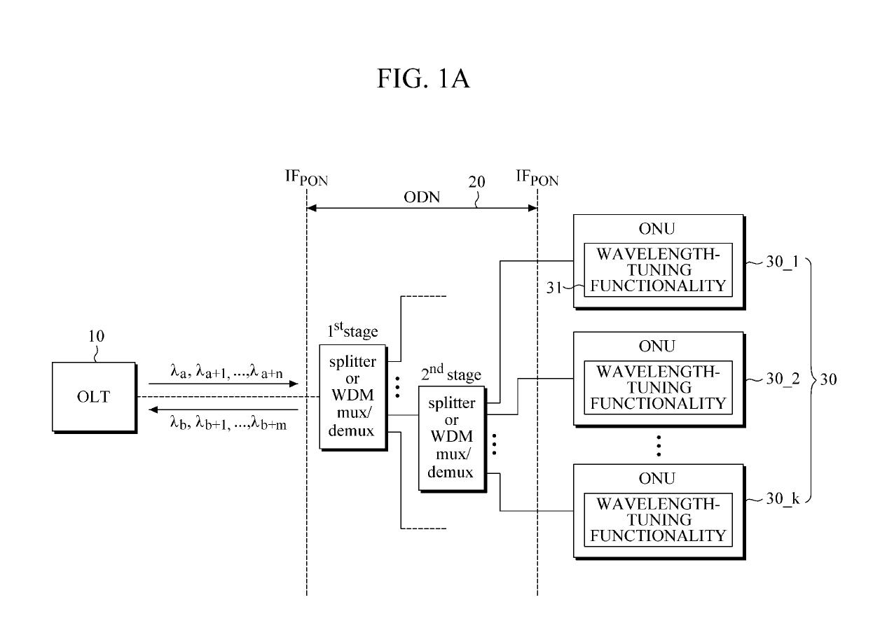

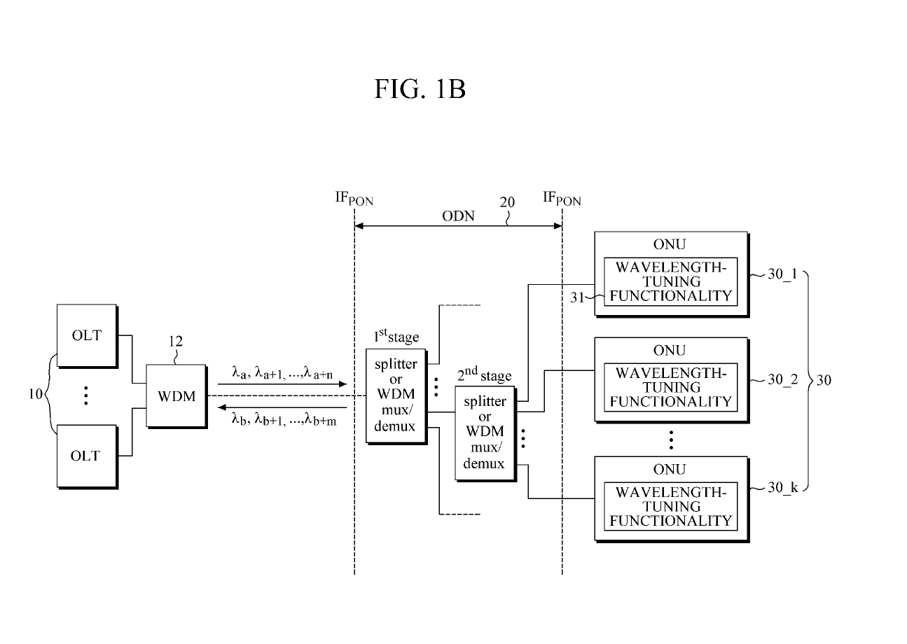

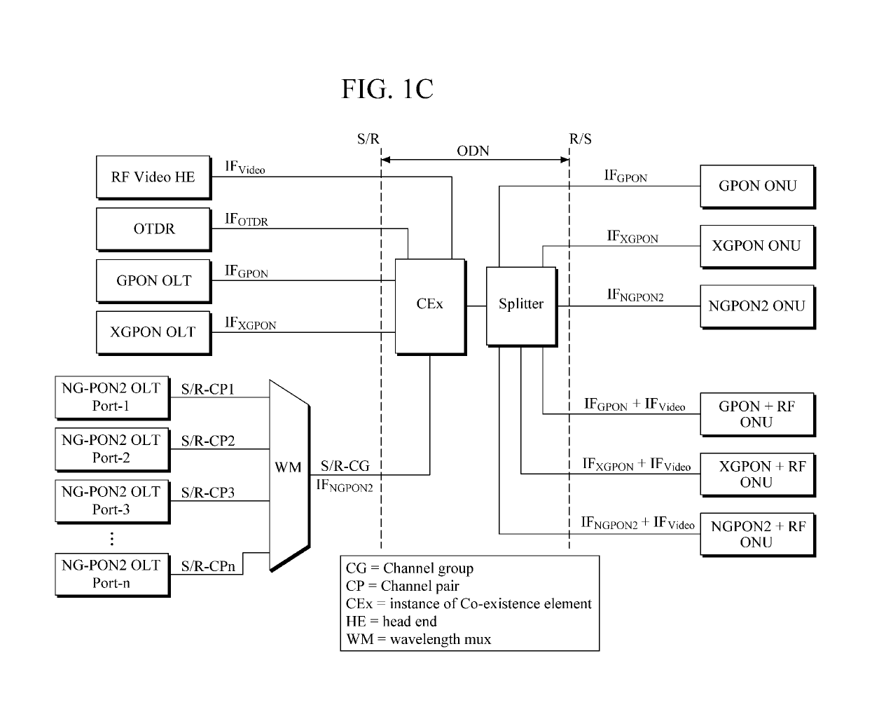

FIG. 1A is a block diagram illustrating an example of an MW PON system including a wavelength-tunable ONU, and FIG. 1B is a block diagram illustrating another example of the MW PON system. FIGS. 1A and 1B differ from each other in terms of whether a single service provider equipment, such as an OLT 10, is included (see FIG. 1A) or a plurality of service provider equipments (OLTs 10) are provided (see FIG. 1B), and accordingly, the system shown in FIG. 1B further includes a WDM unit 12 in a central office side to be connected to the plurality of OLTs 10. In addition, an ONU 30 may provide a wavelength-tuning functionality 31, which is depicted as a block diagram in both FIGS. 1A and 1B for convenience of illustration.

The MW PON system illustrated in FIGS. 1A and 1B is a WDM PON system in which a plurality of subscriber equipments, i.e., a plurality of ONUs 30 do not share a wavelength, a system in which multiple TDM PON systems are stacked on one OLT and different wavelengths are allocated to the respective TDM PON system, or TDM PON systems stacked for each wavelength for supporting traffic load balancing through dynamic wavelength tuning. Alternatively, the MW PON system may be a hybrid PON system in which all characteristics or some characteristics of the above-described systems are merged. In the MW PON system, the ONUs 30 may be classified as one of a plurality of grades on the basis of tunability and/or wavelength tuning speed of the ONUs.

Referring to FIGS. 1A and 1B, the MW PON system includes the OLT 10, an ODN 20, and the ONUs 30. The OLT 10 corresponds to service provider equipment, the ODN 20 corresponds to a local node or an optical distribution network, and the each of the ONUs 30 corresponds to subscriber equipment. One OLT 10 (refer to FIG. 1A) or each of multiple OLTs 10 (refer to FIG. 1B) are located at a central office (CO) side, transmit downlink data λa, λa+1, . . . , and λa+n to the respective ONUs 30, and receive unlink data λb, λb+1, . . . , and λb+m from the respective ONUs 30.

In addition, each of the ONUs 30 of the MW PON system may include a wavelength-tuning functionality 31. The wavelength-tuning functionality 31, which is a module capable of tuning transmitting/receiving wavelengths, may include a wavelength-tunable light source and a wavelength-tunable filter. For example, the wavelength-tuning functionality 31 may be implemented as a wavelength-tunable transceiver. In the exemplary embodiment, the wavelength-tunable transceiver is not limited to a specific type, such that various types of wavelength-tunable transceiver may be used according to the type of MW PON system.

In one aspect, a wavelength-tunable filter may be provided at the front end of an optical transceiver of each ONU 30. The wavelength-tunable filter may be disposed on a common path of the transmission end and the receiving end of the optical transceiver or on a path of the receiving end of the optical transceiver when the optical transceiver uses light of the same uplink/downlink wavelength or the wavelength-tunable filter has free spectral range (FSR) characteristics. For example, the wavelength-tunable filter may be provided at the front end of an optical receiver of the optical transceiver of each ONU 30.

Each of the multiple ONUs 30 establishes a communication link to the OLT 10 using a specific wavelength allocated through wavelength initialization process, and transmits and receives downlink data and uplink data over the established communication link. To establish the communication link, the wavelength-tunable ONU 30 may randomly select a downlink signal or choose a designated downlink signal according to operator's policy. According to the type of MW PON system, each ONU 30 may transmit data within an allocated transmission time period (for example, in a system employing a TDM scheme), but the aspects of the disclosure are is not limited thereto.

Additionally, the ODN 20 may include one or more splitters or WDM multiplexers/demultiplexers (WDM mux/demux) to split/demultiplex a downstream signal transmitted from the OLT 10 by wavelength, and deliver the split/demultiplexed downstream signals to the respective ONUs 30_1, 30_2, . . . , and 30_{—}k, or to combine/multiplex upstream signals received from the respective ONUs 30_1, 30_2, . . . , and 30_{—}k, and deliver the resultant signal to the OLT 10. The splitting/demultiplexing process and the combining/multiplexing process may consist of multiple stages depending on the number of the splitters or optical multiplexers/demultiplexers. Reference “IF_{PON}” in FIGS. 1A and 1B indicates an interface of a passive optical network, and in the exemplary embodiment, it is not limited thereto.

In the MW PON system as illustrated in FIGS. 1A and 1B, a link needs to be established between each of one or more OLTs 10 and each of the plurality of ONUs 30_1, 30_2, . . . , and 30_{—}k to allow the OLTs 10 and the ONUs 30 to communicate data therebetween. The link establishment procedures may be carried out using a physical layer operations administration and maintenance (PLOAM) channel or ONT management control interface (OMCI) channel. In detail, the process may be divided into a stage for allocating, at the OLT 10, wavelengths to the respective ONUs 30_1, 30_2, . . . , and 30_{—}k (in a case of a system employing a TDM scheme, further allocating the time for which each ONU sends an upstream signal using the allocated wavelength), and a stage for initializing the wavelength to use, at each of the multiple ONUs 30_1, 30_2, . . . , and 30_{—}k. Then, the link establishment procedures in the MW PON system 31 with the wavelength-tuning functionality 31 may include a wavelength-tuning process of the wavelength-tuning functionality 31 and the time required to perform the wavelength-tuning process.

In the MW PON system including a splitter-based ODN 20, an ONU that is newly installed in the system, for example, the ONU 30_{—}k, can operate only when allocated an initial signal wavelength. The initial signal wavelength may include a wavelength for downstream and a wavelength for upstream. The process for allocation an initial signal wavelength, namely, signal wavelength initialization process, is considered as prerequisite for activation of each ONU 30_{—}k. When the new ONU 30_{—}k is installed in the ODN 20, the initial downstream and upstream signal wavelengths need to be automatically allocated between the OLT 10 and the new ONU 30_{—}k and at a predetermined interval therebetween. The signal wavelength allocation process may be performed as a part of the activation process of the new ONU 30_{—}k. For appropriate communication between the new ONU 30_{—}k and the OLT 10, the downstream and upstream signal wavelengths for the new ONU 30_K need to be designated as soon as possible and wavelength-tuning may be required while the ONU 30_{—}k is activated. In the MW PON system including an arrayed waveguide grating-(AWG-)based ODN 20, only one signal wavelength from the OLT 10 to the ONU 30 or from the ONU 30 to the OLT 10 may pass through the ODN 20. In this case, the signal wavelength allocation may be performed during physical installation process.

If some wavelengths in the MW PON system have a small traffic or they are in an idle state and the other wavelengths are under heavy load, load balancing in which the signal wavelengths of all or some of the ONUs to which the wavelengths under heavy load are allocated are changed to signal wavelengths in an idle state may be one of examples of change of the signal wavelength allocated to the ONU. According to this, traffics are balanced between available signal wavelengths and the PON operation may be maintained in a stable state. Alternatively, in a case where traffic is small over each signal wavelength while most signal wavelengths are used in the NW PON system, it may be possible to operate the NW PON system more efficiently by reducing the number of used signal wavelengths. In this case, by turning off an arbitrary port of the OLT and varying the ONU to a subset of the available wavelengths, power of the OLT can be saved.

The method of establishing a link in accordance with an exemplary embodiment may be a method for establishing a link for the service provider equipment (OLT 10), the local node (ODN 20), and multiple subscriber equipments (ONUs 30), as shown in FIG. 1A. As described above, this method may include a stage of allocating initial signal wavelengths for a communication between the existing service provider equipment 10 and a new subscriber equipment 30 installed in the local node 20, and a stage for allocating a new signal wavelength to the previously installed subscriber equipment 30 for a communication using the new signal wavelength different from a currently used signal wavelength. In the former case, the signal wavelength initialization process may be performed as a part of the activation process of newly installed subscriber equipment 30.

In addition, the link establishment method may be used for establishing a link for the MW PON system as illustrated in FIG. 1B. The MW PON system shown in FIG. 1B is designed to enable the plurality of OLTs 10 that provide different types of services to share the same fiber. In this case, for establishing a link between one of the OLTs 10 and each ONU 30 (especially, for signal wavelength initialization), the ONU 30 with the wavelength-tuning functionality 31 should possess or have access to the information regarding a wavelength band used by the linked OLT 10. If not having the information regarding the wavelength band, the ONU 30 may need to attempt to perform signal wavelength initialization with respect to the entire wavelength band. In this case, the ONU 30 may require a significant amount of time to perform the signal wavelength initialization, and the wavelength-tuning functionality 31 of the ONU 30, for example, the wavelength-tunable filter and the wavelength-tunable light source, should have a very large working band.

To solve such drawbacks, each ONU 30 may need to internally possess a wavelength plan of the MW PON system shown in FIG. 1B, or need to easily obtain it. In addition, when each ONU 30 knows the wavelength plan of the MW PON system that the ONU 30 itself belongs to, the ONU 30 may choose a downstream signal designated according to the operator's policy. In one example, each ONU 30 may arbitrarily choose a downstream signal in accordance with the wavelength plan that the ONU 30 possesses or have already known. The ONU 30 may obtain information from the downstream signal about the allocated signal wavelength, and depending on the type of system (e.g., a system employing a TDM scheme) it may also obtain information about an available time to send an upstream signal, as a part of the information about the wavelength.

FIG. 1C is a block diagram illustrating an example of the MW PON system illustrated in FIG. 1B. The MW PON system illustrated in FIG. 1C may be an optical network system that is implemented to be capable of accommodating various heterogeneous services, such as TDM-PON, P-to-P, RF video overlay, and the like, in one network, by applying a wavelength-division scheme to the existing passive optical network. In the system configuration as shown in FIG. 1C, an NG-PON2 system may be in a hybrid form combining a TDM scheme and a WDM scheme. The NG-PON2 system with a structure that can support multiple homogeneous service links and/or heterogeneous service links by use of optical signals with various wavelengths is characterized in that it can increase the transmission capacity in proportion to the number of optical wavelength channels, without modifying an optical distribution network used in the existing TDM network.

Referring to FIG. 1C, the NG-PON2 system, that is, the TWDM-PON system, is a hybrid passive optical network that accommodates multiple offices including n optical line terminals (OLTs) that use different wavelengths. Under the assumption that each office accommodates a single PON link, one optical distribution network (ODN) accommodates n homogeneous or heterogeneous networks, and services may be classified according to wavelength band of the signal used. In this case, an NG-PON2 ONU as subscriber equipment of the TWDM-PON system receives a multi-wavelength optical downstream signal, produced by multiplexing optical signals with different wavelengths transmitted from the respective multiple NG-PON2 OLTs. In addition, to communicate with a specific NG-PON2 OLT, it needs to be possible to select a wavelength of an upstream signal corresponding to the downstream signal. Accordingly, the NG-PON2 ONU should include a wavelength-selectable transceiver, i.e., a wavelength-tunable transceiver. The wavelength-tunable transceiver may include a wavelength-tunable laser and a wavelength-tunable receiver.

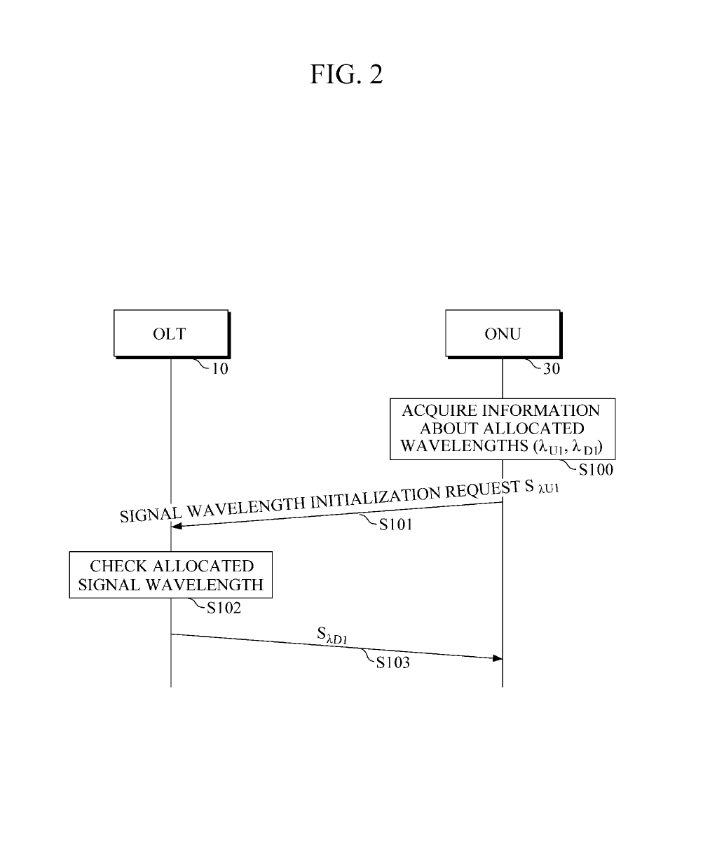

FIG. 2 is a flowchart illustrating link establishment procedures in an MW PON system according to an exemplary embodiment. In the exemplary embodiment, the procedures for establishing a link between an OLT 10 and an ONU 30 include signal wavelength initialization processes S102 and S104. The signal wavelength initialization processes S102 and S104 may include a process of transmitting and receiving signals S_{λa1} and S_{λd1} between physical layer (PHY) of the OLT 10 and physical layer (PHY) of the ONU 30. Further, in a case where the ONU 30 is installed at a local node of the MW PON system for the first time, the aforementioned signal wavelength initialization process may be performed during a physical installation of the new ONU 30. Hereinafter, this process will be described in detail with reference to FIG. 2.

Referring to FIG. 2, in S100, the ONU 30 obtains information about signal wavelengths λu1 and λd1 allocated thereto. Here, the ONU 30 may be subscriber equipment that is installed at a local node of the MW PON system for the first time, or subscriber equipment that wishes to remove the existing link and create a new link to communicate with the OLT 10 through a signal wavelength that is different from the currently used signal wavelength. Further, in this stage, the ONU 30 may identify the information about the signal wavelengths λu1 and λd1 allocated thereto in accordance with the wavelength plan of the MW PON system which the ONU 30 itself possesses, or may receive information about the signal wavelengths λu1 and λd1 allocated from an external source. For example, the wavelength-tunable ONU 30 may arbitrarily choose a downstream signal in conformity with the operator's policy, or choose a downstream signal allocated thereto by the operator, and may obtain the information about the allocated signal wavelengths λu1 and λd1 from information contained in the downstream signal. In addition, as described above, in the case of the MW PON system employing a TDM scheme, the ONU 30 may identify an available time at which to send an upstream signal, based on time information included in the wavelength information contained in the downstream signal.

Then, in S101, the ONU 30 transmits a signal wavelength initialization request signal S_{λu1} to the OLT 10. In one aspect, the signal wavelength initialization request signal S_{λu1} may be automatically issued by physical layer; this indicates that the signal wavelength initialization request signal S_{λu1} is a signal that is transmitted on a particular wavelength λu1 from physical (PHY) layer without exchanging a signal with media access control (MAC) layer or any other higher layer. In one exemplary embodiment, the signal wavelength initialization request signal S_{λu1} only refers to a signal that the ONU 30 transmits from physical layer using an upstream signal wavelength λu1 allocated thereto, and the signal S_{λu1} has no limitations in its format or information contained therein.

In another aspect, the signal wavelength initialization request signal S_{λu1} may be transmitted on a wavelength (for example, an allocated wavelength identified through information contained in the downstream signal from the OLT 10) chosen through MAC layer. In this case, in the MW PON system employing a TDM scheme, the signal wavelength initialization request signal S_{λu1} may be only transmitted at the time that is identified from the wavelength information contained in the downstream signal, that is, the time allocated to the ONU 30.

In addition, in S102, the OLT 10 that has received the signal wavelength initialization request signal S_{λu1} checks whether the received signal is consistent with the signal wavelength allocated to the ONU 30. Such checking is performed to determine whether the signal received from the ONU 30 is a signal of a wavelength operated by the OLT 10 and/or whether the signal consistent with the signal wavelength allocated for use of the ONU 30. More specifically, the former is the checking process that may be automatically performed on physical layer of the OLT 10. The latter is the checking process that may be performed on MAC layer through the signal exchange between PHY layer of the OLT 10 that has received the signal wavelength initialization request signal and the MAC layer.

In response to the completion of wavelength check, the OLT 10 transmits a signal wavelength initialization response signal S_{λd1} to the ONU 30 in S103. The signal wavelength initialization response signal S_{λd1} refers to a signal that is directly transmitted from PHY layer of the ONU 30 or a signal that is transmitted on a specific wavelength λd1 based on checking at the MAC layer. In one exemplary embodiment, the signal wavelength initialization request signal S_{λu1}, which is received in S103, is not consistent with the wavelength used by the OLT 10 or the requested signal wavelength is not allocated to the ONU 30, the OLT 10 may not transmit any response to the ONU 30. However, if the signal wavelength initialization request signal S_{λu1} received in S101 is consistent with the wavelength used by the OLT 10 and/or the requested signal wavelength is a signal wavelength that is allocated to the ONU 30, the OLT 10 transmits the response signal from PHY layer to the ONU 30 by use of the downstream signal wavelength λd1 allocated to the ONU 30. In the example, the signal wavelength initialization response signal S_{λd1} is not limited in the format thereof or types of information contained therein.

Then, in order to establish a link, general procedures necessary between the OLT 10 and the ONU 30 are performed. Such procedures may vary according to the MW PON system's specifications, and all necessary procedures may be performed according to the current specifications or newly updated specifications.

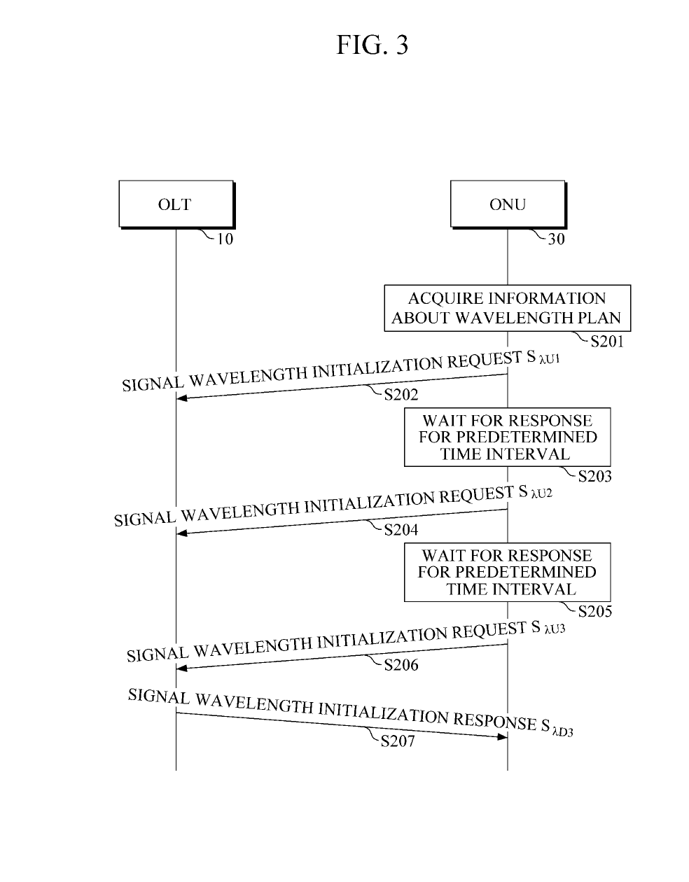

FIG. 3 is a flowchart illustrating procedures for establishing a link in an MW PON system according to another exemplary embodiment. In one exemplary embodiment, the procedures for establishing a link between the OLT 10 and the ONU 30 include signal wavelength initialization processes S202, S204, S206, and S207. The signal wavelength initialization processes S202, S204, S206, and S207 may include processes of transmitting and receiving signals S_{λu1}, S_{λu2}, S_{λu3}, and S_{λd3} between PHY layer of the OLT 10 and PHY layer of the ONU 30. In addition, if the ONU 30 is installed at a local node of the MW PON system for the first time, the signal wavelength initialization processes may be performed during the physical installation of the ONU 30. Hereinafter, this will be described in detail with reference to FIG. 3.

Referring to FIG. 3, in S200, the ONU 30 acquires information about signal wavelengths allocated thereto. Here, the ONU 30 may be subscriber equipment that is installed at a local node of the MW PON system for the first time, or subscriber equipment that wishes to remove the existing link and create a new link to communicate with the OLT 10 through a signal wavelength that is different from the currently used signal wavelength. In addition, in this stage, the ONU 30 may identify pieces of information about the signal wavelengths λu1˜λun and λd1˜λdn (here, n is an integer greater than 2) allocated thereto in accordance with the wavelength plan of the MW PON system which the ONU 30 itself possesses, or may receive information about the signal wavelengthsλu1˜λun and λd1˜λdn (here, n is an integer greater than 2) allocated from an external source.

In one example, the ONU 30 may acquire information about wavelengths allocated through the downstream signal from the OLT 10. In this case, the ONU 30 may receive the downstream signal containing such wavelength information from the OLT 10, and the ONU 30 may identify the wavelength of the signal wavelength initialization request signal S_{λu1} through MAC layer. Further, in the case of the system employing the TDM scheme, the ONU 30 may identify an available time to transmit an upstream signal, based on the wavelength information contained in the downstream signal from the OLT 10.

Further, in S201, the ONU 30 transmits the first signal wavelength initialization request signal S_{λu1} to the OLT 10. In one aspect, the signal wavelength initialization request signal S_{λu1} may be automatically issued from PHY layer of the ONU 30; this indicates that the signal wavelength initialization request signal S_{λu1} is a signal that is transmitted on a particular signal wavelength λu1 from physical (PHY) layer without exchanging a signal with media access control (MAC) layer or any other higher layer. In this example, the signal wavelength initialization request signal S_{λu1} only refers to a signal that is transmitted from PHY layer of the ONU 30 using the upstream signal wavelengthλu1 allocated to the ONU, and the signal S_{λu1} is not limited in the format thereof and types of information contained therein. In another aspect, a wavelength of the signal wavelength initialization request signal S_{λu1} may be chosen through MAC layer (for example, a wavelength allocated in accordance with the information contained in the downstream signal from the OLT 10 may be identified), and a time at which the signal wavelength initialization request signal S_{λu1} is to be transmitted may be chosen through MAC layer (for example, the corresponding time information contained, along with the wavelength information, in the downstream signal from the OLT 10 may be identified), as described above. In addition, the ONU 30 waits for a response from the OLT 10 for a predetermined time interval is in S203. Here, the time interval may be previously set according to the specifications of the MW PON system, or it may be previously set by the ONU's own function or by a user. The time interval is a time period for which the ONU 30 that has transmitted the signal wavelength initialization request signal on a specific wavelength stands by until starting the signal wavelength initialization process (i.e., starts operation S201) by changing the signal wavelength to another wavelength. In one example, the ONU 30 may change the used signal wavelength to the different wavelength after repeatedly transmitting the signal wavelength initialization request signal for several times, and in this case, the same time interval as will be described below may be applied.

In this example, the time interval may be determined by taking into account at least a propagation delay time of an optical signal and a signal processing time taken by the OLT 30 to process a signal. Here, the “propagation delay time of an optical signal” refers to a time taken to transmit the signal wavelength initialization request signal or a response signal to the request signal in the network. Further, the “signal processing time” refers to a time taken by the OLT 30 to process the received signal wavelength initialization request signal and, in response to the request signal, generate and transmit a signal wavelength initialization response signal.

In one aspect, the time interval for standby in S203 may be decided by Equation 1 below. The time interval may be shorter than a time taken by the response signal to the last signal wavelength initialization request signal to reach the ONU 10.

Time interval=2τP+τOffice+τG (1)

Here, “τP” denotes a propagation delay time, “τOffice” denotes a signal processing time of the ONU 10, and “τG” denotes a guard time. The “guard time” is set by taking into consideration a time delay that may occur in the process of signal wavelength initialization, and the duration of the guard time may be determined according to specifications of a system and/or policies by service provider equipment, with no limitation thereto being intended.

Still referring to FIG. 3, if it fails to receive a response to the signal wavelength initialization request signal S_{λu1} that has been transmitted from the OLT 10 in S202, even after standing by for a predetermined period of time in S203, the OLT 30 transmits the second signal wavelength initialization request signal S_{λu2} to the OLT 10 in S204. In one aspect, the second signal wavelength initialization request signal S_{λu2} may be automatically issued from PHY layer of the ONU 30; this indicates that the signal wavelength initialization request signal S_{λu2} is a signal that is transmitted on a particular signal wavelength λu1 from physical (PHY) layer without exchanging a signal with media access control (MAC) layer or any other higher layer. Also, in the exemplary embodiment, the signal wavelength initialization request signal S_{λu2} only refers to a signal that is transmitted from PHY layer of the ONU 30 using an upstream signal wavelength λu2 allocated to the ONU 30, and the signal S_{λu2} is not limited in the format thereof or types of information contained therein.

In another aspect, to transmit the signal wavelength initialization request signal S_{λu1} on a wavelength that is different from the wavelength used in S202, operation S201 in which the downstream signal is received may be repeated. In this case, the ONU 30 may acquire information about a new signal wavelength λu2 allocated thereto based on information contained in the newly received downstream signal, and transmit the signal wavelength initialization request signal to the OLT 10 using the new signal wavelength λu2. In addition, the ONU 30 waits again for a response from the OLT 10 for a predetermined time interval in S205. In S205, if it fails to receive a response to the signal wavelength initialization request signal S_{λu1} that has been transmitted from the OLT 10 in S204, even after standing by for a predetermined period of time in S205, the OLT 30 transmits the third signal wavelength initialization request signal S_{λu3} to the OLT 10 in S206.

Although not illustrated in drawings, the OLT 10 that receives the signal wavelength initialization request signals S_{λu1}, S_{λu21}, and S_{λu3} in the respective operations S202, S204, and S206 checks whether the received signal is consistent with the signal wavelength allocated to the ONU 30. Such checking is performed to determine whether the signal received from the ONU 30 is a signal of a wavelength operated by the OLT 10 and/or whether the signal is consistent with the signal wavelength allocated for use of the ONU 30. More specifically, the former is the checking process that may be automatically performed on physical layer of the OLT 10. The latter is the checking process that may be performed on MAC layer through the signal exchange between PHY layer of the OLT 10 that has received the signal wavelength initialization request signal and the MAC layer. If the wavelength check result indicates that the received signal wavelength initialization request signals S_{λu1} and S_{λu2} are not signal wavelengths used by the OLT 10 or they are not the signal wavelengths allocated to the ONU 30, the OLT 10 may not transmit any response to the ONU 30 at all. However, if the check result indicates that the received signal wavelength initialization request signal S_{λu1} is a signal wavelength used by the OLT 10 and/or a signal wavelength allocated to the ONU 30, the OLT 10 transmits the signal wavelength initialization response signal from PHY layer to the ONU 30 by use of a downstream signal wavelength λd3 allocated to the ONU 30 in S207. The signal wavelength initialization response signal S_{λd3} may be a signal that is directly transmitted from PHY layer of the ONU 30, or may be a signal that is transmitted on a particular wavelength λd3 based on the checking at MAC layer. In the exemplary embodiment, the signal wavelength initialization response signal S_{λd3} may not be limited to the format thereof or types of information contained therein.

Then, in order to establish a link, general procedures necessary between the OLT 10 and ONU 30 are performed. Such procedures may vary according to the MW PON system's specifications, and all necessary procedures may be performed according to the current specifications or newly updated specifications.

In addition, in the MW PON system as shown in FIG. 1B and FIG. 1C, which is an example of FIG. 1B, multiple downstream and upstream signals of a WDM scheme are operated like in a general WDM system. In this case, when signal performance (of an upstream signal and a downstream signal) is evaluated at a front end of each of the OLT and ONU, and more particularly, an IFPON interface of FIG. 1B or an S/R interface and R/S interface of FIG. 1C, it needs to measure a signal of a single wavelength selected from among multiple signals. In this case, to select the signal of a single wavelength, an optical filter (hereinafter, will be referred to as an optical filter for measurement) for the single wavelength needs to be used.

Due to the characteristics of the MW PON system, the design of the optical filter for measurement needs to take into consideration isolation from other channels which are used to provide different services, as well as from neighboring channels. More specifically, in a case of the system structure in which various services are provided using a single optical link as shown in FIG. 1C, the optical filter for measurement needs to be designed by taking into consideration the isolation from the other service channels, as well as the neighboring channels.

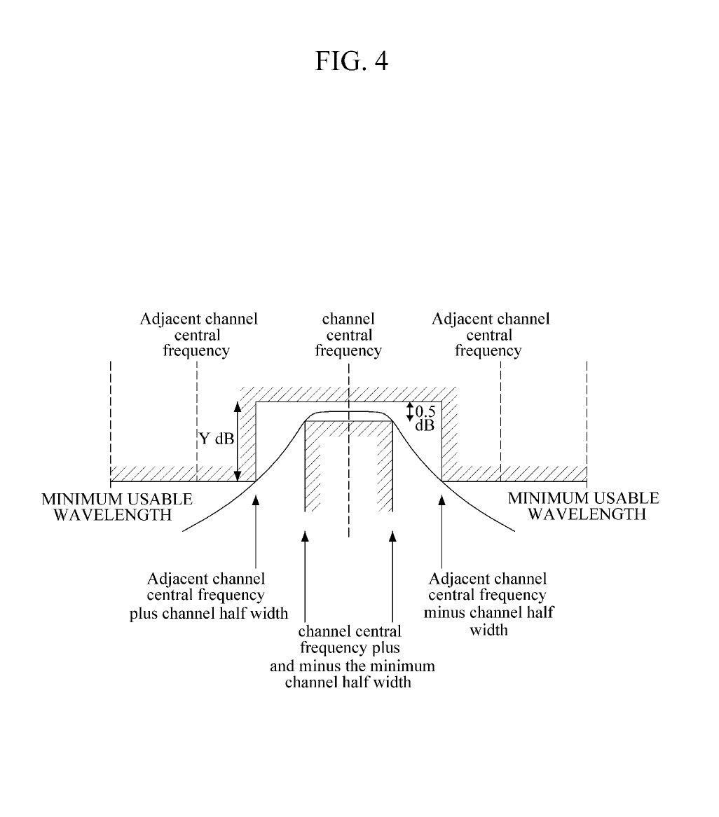

FIG. 4 is a graph showing characteristics of the optical filter for measurement. In one example, in FIG. 4, Y should be determined in consideration of the sum of optical powers at the neighboring channel and at a channel used for another service; and the filtered channel intensity. Further, the optical filter for measurement may be implemented as a wavelength-tunable filter.

According to the aforementioned exemplary embodiments, the signal wavelength initialization process may be performed at PHY layer of each of the OLT and the ONU in the MW PON system. Therefore, the signal wavelength initialization process can be easily carried out, regardless of a network configuration of the MW PON system, and also compatibility with the existing products can be obtained. In addition, the exemplary embodiments may be implemented in a TDWM PON system in which a TDM scheme and a WDM scheme are combined.

Moreover, according to the exemplary embodiments, easy product applications are possible with simple technical implementation, price competitiveness can be achieved by utilizing conventional devices of commercially available products, and it is also possible to secure a space within an optical transceiver (OTRx) in comparison with the related techniques. Further, according to the exemplary embodiments, it is possible to provide compatibility with other products and allow for flexible application of an optical transceiver to a network, and it is also possible to save energy in the optical transceiver located at an office and to maintain the intensity of optical light to be low, which is input as optical power, thereby improving management stability of an optical fiber.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of establishing a link in a multi-wavelength passive optical network (MW PON) system, the method comprising:
initializing a signal wavelength between service provider equipment and subscriber equipment which are included in the MW PON system,
wherein the initializing of the signal wavelength comprises transmitting and receiving signals between physical layer of the service provider equipment and physical layer of the subscriber equipment.

2. The method of claim 1, wherein, in a case where the subscriber equipment is installed in the MW PON system, the transmitting and receiving of the signals is performed during physical installation of the subscriber equipment.

3. The method of claim 1, wherein the transmitting and receiving of the signal comprises transmitting a first signal-wavelength initialization request signal on a first upstream wavelength from the physical layer of the subscriber equipment to the service provider equipment, and receiving a signal wavelength initialization response signal on a first downstream wavelength from the physical layer of the service provider equipment.

4. The method of claim 3, wherein the transmitting of the signal comprises transmitting the first signal-wavelength initialization request signal on the first upstream wavelength based on information about a wavelength plan of the MW PON system which has been previously obtained prior to the transmitting of the signal.

5. The method of claim 3, wherein the receiving of the signal comprises receiving the signal wavelength initialization response signal that is automatically transmitted from the physical layer of the service provider equipment.

6. The method of claim 3, wherein the receiving of the signal comprises receiving the signal wavelength initialization response signal that is transmitted after wavelength allocation to the subscriber equipment is checked at media access control (MAC) layer of the service provider equipment.

7. The method of claim 3, further comprising:
waiting for a response for a predetermined time interval after transmitting the first signal wavelength request signal; and
in response to failing to receive the signal-wavelength initialization request signal during the waiting, transmitting a second signal wavelength initialization request signal on a second upstream wavelength to the service provider equipment after the predetermined time interval.

8. The method of claim 7, further comprising:
waiting for a response for a predetermined time interval after transmitting the second signal wavelength initialization request signal; and
in response to failing to receive the signal wavelength initialization request signal during the waiting, transmitting a third signal wavelength initialization request signal on a third upstream wavelength to the service provider equipment after the predetermined time interval.

9. The method of claim 7, wherein the time interval is “2τP+τOffice+τG,” where τP represents a propagation delay time, τG represents a signal processing time of an optical network unit and τG represents a guard time.

10. A method of subscriber equipment to establish a link to service provider equipment in a multi-wavelength passive optical network (MW PON) system, the method comprising operations of:
(a) acquiring information about a wavelength plan of allocated wavelengths in the MW PON system;
(b) transmitting a first signal wavelength initialization request signal on a first upstream wavelength from physical layer of the subscriber equipment to the service provider equipment;
(c) waiting for a response from the service provider equipment for a predetermined time interval after transmitting the first signal wavelength initialization request signal; and
(d) in response to failing to receive a response to the first signal-wavelength initialization request signal within the predetermined time interval, transmitting a second signal wavelength initialization request signal on a second upstream wavelength to the service provider equipment after the waiting.

11. The method of claim 10, further comprising operations of:
(e) waiting for a response from the service provider equipment for a predetermined time interval after transmitting the second signal wavelength initialization request signal; and
(f) in response to failing to receive a response to the second signal wavelength initialization request signal within the predetermined time interval, transmitting a third signal wavelength initialization request signal on a third upstream wavelength after the waiting.

12. The method of claim 10, wherein the time interval is “2τP+τOffice+τG,” where τP represents a propagation delay time, τG represents a signal processing time of an optical network unit and τG represents a guard time.

13. The method of claim 10, wherein the operation (a) comprises receiving a first downstream signal from the service provider equipment and the first upstream wavelength is identified by information contained in the first downstream signal.

14. The method of claim 13, wherein the operation (d) comprises receiving a second downstream signal from the service provider equipment, and the second upstream wavelength is identified by information contained in the second downstream signal.
